(19) United States
(12) Patent Application Publication
(10) Pub. No.: US 2023/0114855 A1
(43) Pub. Date: Apr. 13, 2023

(54) PULLING DEVICE FOR A CLAMPING DEVICE AND CLAMPING DEVICE EQUIPPED THEREWITH

(71) Applicant: REISHAUER AG, Wallisellen (CH)

(72) Inventors: Roman Zimmermann, Dottingen (CH); Benjamin Gehring, Glattfelden (CH); Saip Semsedini, Hausen (CH); Dominik Michael Stäubli, Zurich (CH)

(73) Assignee: REISHAUER AG, Wallisellen (CH)

(21) Appl. No.: 17/961,779

(22) Filed: Oct. 7, 2022

(30) Foreign Application Priority Data
Oct. 7, 2021 (CH) 070356/2021

(51) Int. Cl. B23B 31/30

(52) U.S. Cl. CPC B23B 31/302

(57) ABSTRACT

A pulling device for generating a pulling movement in a clamping device has a pull-acting hydraulic working cylinder with a pull piston displaceable therein and a pull rod connected to the pull piston. In order to make the pulling device particularly compact and easy to maintain, the pulling device also has a push-acting hydraulic pump cylinder with a pump piston displaceable therein and a fluidic connection between the pump cylinder and the working cylinder. A movement of the pump piston in a pushing direction causes the hydraulic fluid to flow from the pump cylinder into the working cylinder, where it causes a pulling movement of the pull piston in a pulling direction. The pulling direction is opposite to the pushing direction, and the pump cylinder and the working cylinder are arranged coaxially to each other.

### TECHNICAL FIELD

The present invention relates to a pulling device for actuating a clamping device and to a clamping device equipped therewith.

### PRIOR ART

Rotating parts, in particular workpieces and tools, frequently have to be clamped in machine tools. Clamping devices are used for this purpose. A clamping device has a clamping device base that forms an interface to a machine structure. The machine structure may in particular be a workpiece spindle or tool spindle or a base unit which is itself mounted on such a spindle. A clamping device further comprises a clamping element for connection to the part to be clamped, e.g. a workpiece or tool.

A distinction is made in particular between hydraulic clamping elements and mechanical clamping elements. Mechanical clamping elements are often actuated by an axial pulling movement directed away from the clamping element in order to clamp or release the part to be clamped. A device is then required with which this pulling movement can be generated.

For this purpose, it is known from the prior art to provide, in the clamping device base, a hydraulic pull cylinder with a hydraulically movable pull piston. Under the pressure of a hydraulic medium, the pull piston performs an axial pulling movement directed away from the clamping element. A pull rod (drawbar) transmits the pulling movement to the clamping element. The return of the pull piston to its initial position is effected by several return springs which are arranged in the hydraulic cylinder and act on the pull piston from the side opposite to the hydraulic medium. The hydraulic pressure is supplied to the clamping device by an external hydraulic pump through an interface. Such a clamping device is offered by Reishauer AG with the designation “DME” and is mentioned in the brochure “REISHAUER Clamping Systems mechanically expanding”, downloaded from www.reishauer.com on Sep. 20, 2021.

In clamping devices of the type mentioned, the clamping device base must be dismantled in the event of a malfunction of the pull cylinder. The clamping device base is essential for the precision of the clamping device (especially for concentricity and axial runout). After reassembly of the clamping device, the clamping device base must therefore usually be reground.

Another disadvantage of clamping devices of this type is that the hydraulic cylinder takes up a relatively large amount of space. This is primarily due to the fact that the external hydraulic pressure available is limited by system limitations. In order to generate a sufficiently large clamping force with the available pressure, the cross-sectional area of the pull piston must therefore be relatively large, which leads to a high space requirement for the hydraulic cylinder.

Another disadvantage of clamping devices of the type mentioned is that the restoring force generated by the restoring springs cannot be changed. If the restoring force is to be increased, for example, the clamping device must be dismantled in order to install stronger restoring springs, which in turn usually requires reworking of the clamping device base.

Conventional clamping devices of the type mentioned above are therefore inflexible, not very maintenance-friendly and require a lot of space.

### SUMMARY OF THE INVENTION

It is an object of the present invention to provide a pulling device for generating a pulling movement in a clamping device, said mechanism allowing easy operation and maintenance and being compactly realizable.

A pulling device for generating a pulling movement in a clamping device is disclosed, comprising:
a pull-acting hydraulic working cylinder having a pull piston displaceable along a longitudinal axis;
a pull rod connected to the pull piston;
a push-acting hydraulic pump cylinder having a pump piston displaceable therein; and
a fluid connection between the pump cylinder and the working cylinder so that a hydraulic fluid is interchangeable between the pump cylinder and the working cylinder.

The pulling device is configured in such a way that a movement of the pump piston in a pushing direction along the longitudinal axis causes the hydraulic fluid to flow from the pump cylinder into the working cylinder, where it causes a pulling movement of the pull piston and the pull rod connected to it in a pulling direction along the longitudinal axis, the pulling direction being opposite to the pushing direction. The pump cylinder and the working cylinder are arranged coaxially to each other in a common housing.

The invention takes advantage of the fact that a push piston for generating a pushing movement along the pushing direction is often already present near the clamping device. For example, the clamping device may be mounted on a base unit, which in turn is mounted on a workpiece or tool spindle of a machine tool, and the base unit may comprise said push piston. The pulling device now converts the pushing movement along the pushing direction into a pulling movement along the pulling direction, which is opposite to the pushing direction, and thus enables actuation of the clamping device. By arranging the pump cylinder and the working cylinder coaxially with each other in a common housing, the result is an easily replaceable, compact unit which does not require any hydraulic connections for its operation and which can be easily removed from the clamping device for maintenance purposes without having to perform complex disassembly work.

By a suitable choice of the cross-sectional areas of the pump piston and the pull piston, a hydraulic pressure ratio and, if necessary, also a hydraulic force ratio can be realized very easily. In particular, the cross-sectional area of the pump piston can be selected to be smaller than the cross-sectional area of the external push piston used to generate the pushing movement of the pump piston. As a result, a hydraulic pressure can be generated in the pump cylinder that is significantly higher than the external hydraulic pressure acting on the external push piston. Because of this hydraulic pressure ratio, the pulling device can be made much more compact than if the pull piston were operated with an external hydraulic pressure. On the other hand, the cross-sectional area of the pump piston can be selected to be smaller than the cross-sectional area of the pull piston. As a result, the hydraulic pressure generated by the pump cylinder can be used to generate a pulling force at the pull piston that is higher than the external pushing force acting on the pump piston (hydraulic force ratio). Overall, a high pulling force can be achieved with very little space requirement.

Preferably, the working cylinder is annular and radially surrounds the pump cylinder. This results in a particularly compact arrangement with low length requirements along the longitudinal axis.

The following design solution, which is particularly easy to implement, may be chosen: The housing has a continuous central bore along the longitudinal axis. An insert is accommodated in the central bore. The pull piston is annular and is displaceably arranged in an annular space between the insert and the housing. The annular space thus forms the working cylinder. The pull rod extends outward through the central bore of the housing. The pump piston is displaceably arranged in a central bore of the insert. The central bore of the insert thus forms the pump cylinder. The central bore of the insert is fluidically connected to the annular space between the insert and the housing through one or more lateral openings in the insert.

Preferably, the pulling device also comprises a return spring for returning the pull piston to an initial position. The return spring is preferably configured as a compression spring and is arranged axially between a support element fixed relative to the housing and a counterpressure element connected to the pull rod in such a way that the pulling movement of the pull rod causes compression of the return spring. The support element can be formed by a wall area of the housing on a face side thereof or by a separate element. In particular, the return spring is preferably not arranged in the working cylinder. Preferably, it is arranged outside the housing to ensure easy accessibility.

The axial position of the counterpressure element on the pull rod is preferably adjustable in order to change the biasing force of the return spring. For this purpose, the pull rod can have an external thread, and the counterpressure element can have an internal thread complementary to the external thread, so that the axial position of the counterpressure element on the pull rod can be changed by a simple screw connection. In other words, the counterpressure element may be formed as a nut or comprise a nut. Instead, however, the axial adjustability can also be achieved in other ways, for example by means of a locking ring or clamps.

In advantageous embodiments, the return spring is configured as an elastomer spring, i.e. made of an elastomeric plastic material. However, it can also be designed differently, e.g. as a helical spring or disc spring.

A particularly simple design is achieved if the return spring radially surrounds the pull rod. However, it is also conceivable to arrange the return spring laterally offset from the pull rod. In this case in particular, it is also conceivable to provide two or more return springs distributed around the pull rod in the circumferential direction. It is also conceivable to dispense with a return spring on the pulling device itself and to ensure the return in another way, e.g. by providing a return spring at another point in the clamping device.

The invention also provides a clamping device which comprises:
a one-piece or multi-piece base body forming a clamping device base for connection to a machine part;
a pull-actuated clamping element for making a clamping connection with an object to be clamped; and
a pulling device of the type mentioned above,
   wherein the pulling device is detachably arranged in the base body, and
   wherein the clamping element is detachably connected to the pull rod of the pulling device in such a way that the clamping element can be actuated by the pulling movement of the pull rod.

In this case, the pulling device is preferably accommodated in the base body in such a way that it can be completely removed from the base body without dismantling the base body, in particular without removing the clamping device base from the clamping element.

In particular, the clamping device may comprise a securing element for this purpose, which effects a releasable connection between the base body and the pulling device, the pulling device being fixed to the base body in a fixed state of the securing element and being removable from the base body in a released state of the securing element. The securing element may, for example, be one or more radial screws or a securing ring.

The base body may include a bore, and the pulling device may then be received in the bore such that it is completely removable from the base body along the longitudinal axis of the pulling device without disassembling the base body. In preferred embodiments, the bore is a central axial bore along a central longitudinal axis of the clamping device. However, the bore may also be, for example, oblique or even transverse to the longitudinal axis of the clamping device. If the longitudinal axis of the pulling device does not coincide with the longitudinal axis of the clamping device, it may be provided that the pulling movement is deflected in a suitable manner, as is known per se from the prior art.

If the pulling device does not already itself comprise a return spring to return the pull piston of the pulling device to its initial position, such a return spring can be provided at another point in the clamping device. It is also conceivable to provide a first return spring in the pulling device and a second return spring at another point in the clamping device.

### BRIEF DESCRIPTION OF THE DRAWINGS

Preferred embodiments of the invention are described below with reference to the drawings, which are for explanatory purposes only and are not to be construed as limiting. In the drawings:

FIG. 1 shows a pulling device according to an embodiment of the invention in a central longitudinal section; and

FIG. 2 shows a clamping device with a pulling device according to FIG. 1 in installed condition.

### DESCRIPTION OF PREFERRED EMBODIMENTS

### Example of a Pulling Device

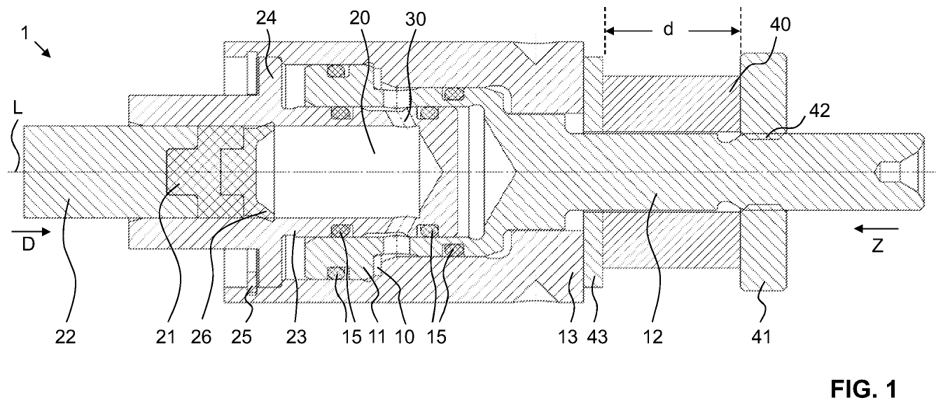

FIG. 1 illustrates a pulling device 1 according to an embodiment of the invention.

Directional designations are used below as follows: The pulling device 1 defines a central longitudinal axis L. A pushing direction D points to the right along the longitudinal axis L in FIG. 1. Thus, a direction “to the right” in the following means the pushing direction D. A pulling direction Z is opposite to the pushing direction D and accordingly points to the left in FIG. 1. Thus, by a direction “to the left” is meant in the following the pulling direction Z. An essential function of the pulling device 1 is to convert a pushing movement in the pushing direction D (i.e. to the right) into a pulling movement in the pulling direction Z (i.e. to the left).

The pulling device 1 comprises a housing 13 whose outside is cylindrical. A continuous central bore is formed along the longitudinal axis L in the housing 13. The bore tapers in several steps from left to right. An insert 23 is inserted into the bore from the left side. With a radially protruding annular flange 24, the insert 23 rests against the end face of an inner shoulder region of the housing 13 in the region of one of the steps of the bore. This prevents the insert 23 from being inserted axially further to the right into the housing 13. The insert 23 is prevented from moving to the left out of the bore by means of a locking ring 25, which engages in an internal annular groove in the housing 13. Overall, the insert 23 is thus fixed axially and radially in the housing 13.

Between the insert 23 and the housing 13 there is an annular space in which an annular pull piston 11 is axially displaceably arranged. A pull rod 12 is integrally connected to the pull piston 11. The pull rod 12 is also annular in cross section in the area of the annular space. It extends from the pull piston 11 through the annular space and out through the central bore of the housing 13 to the right. The pull piston 11 and the annular area of the pull rod 12 are circumferentially sealed with sealing rings 15 both with respect to the housing 13 and with respect to the insert 23. The insert 23, the housing 13 and the pull piston 11 together define an annular cavity, the volume of which depends on the axial position of the pull piston 11. This cavity can be pressurized with a hydraulic fluid to push the pull piston 11 to the left in the pulling direction Z. The housing 13, the insert 23 and the pull piston 11, which is displaceably arranged between them, thus form a pull-acting working cylinder 10.

The insert 23 has a central cylindrical bore, which is open to the left along the longitudinal axis L. A pump piston 21 with a circumferential piston seal 26 is displaceably arranged in the bore. The insert 23 and the pump piston 21, which is displaceable therein, jointly delimit a cylindrical cavity, the volume of which depends on the axial position of the pump piston 21. By moving the pump piston 21 to the right in the pushing direction D, hydraulic fluid can be forced out of the cavity. The insert 23 and the pump piston 21, which is displaceably arranged therein, thus form a push-acting pump cylinder 20. A piston rod 22 serves to actuate the pump piston 21.

The pump cylinder 20 and the working cylinder 10 are fluidically connected to each other by several lateral bores in the insert 23 and lateral openings in the annular area of the pull rod 12. As a result, there is a fluid connection 30 between the pump cylinder 20 and the working cylinder 10.

If the piston rod 22 is moved to the right in the pushing direction D, hydraulic fluid is forced from the pump cylinder 20 into the working cylinder 10, where it causes the pull rod 12 to move to the left in the pulling direction Z. Overall, a pushing movement of the piston rod 22 in the pressure direction D is thus converted into a pulling movement of the pull rod 12 in the pulling direction Z.

FIG. 1 shows the initial position or rest position of the pull piston 11. The pull rod 12 is prevented from moving further to the right against the pulling direction. In order to cause the pull rod 12 to return to this initial position after actuation of the pulling device 1, the pulling device 1 comprises a return spring 40. In the present embodiment, this return spring 40 is configured as an annular elastomer spring and surrounds the pull rod 12.

A counterpressure element 41 is connected to the pull rod 12 to compress the return spring 40 during the pull rod's pulling movement. The return spring 40 is arranged axially between the counterpressure element 41 and an annular support element 43 fixed to the housing. In the initial position of the pull piston 11, the return spring 40 is elastically preloaded (biased). The preload (biasing) force can be varied by changing the distance d (“adjustment dimension”) between the support element 43 and the counterpressure element 41. In addition, the preload force can be changed by the axial thickness of the support element 43. The support element 43 can also be omitted; in this case, a right-hand outer end wall area of the housing 13 assumes the function of the support element.

In order to be able to change the adjustment dimension d easily, the counterpressure element 41 in the present embodiment is configured as a threaded nut, which engages with its internal thread 42 in an external thread of the pull rod 12. The adjustment dimension d can be set very easily and precisely by a screw movement of the threaded nut.

To ensure easy accessibility of the return spring 40, it is arranged outside the housing 13. However, the housing 13 may also radially surround at least part of the return spring 40 as long as it is ensured that the counterpressure element 41 remains easily accessible.

### Installation in a Clamping Device

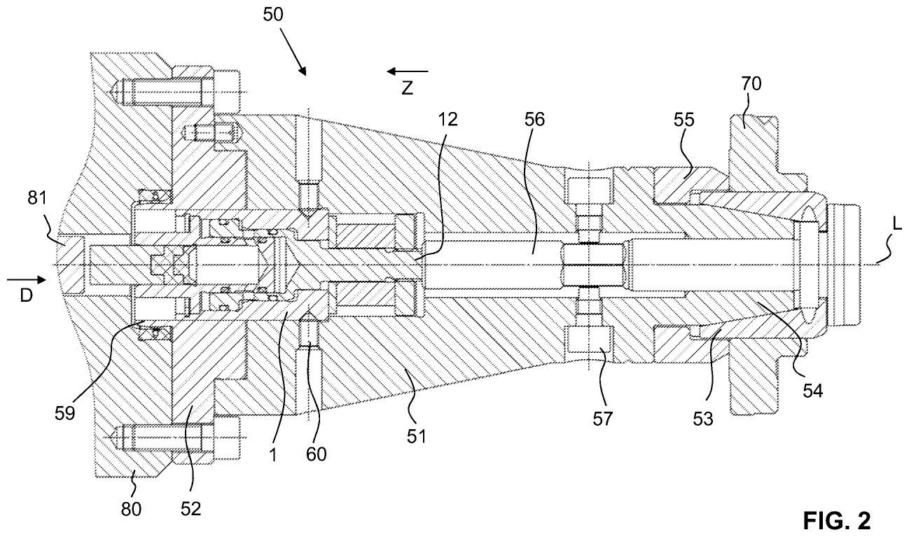

FIG. 2 shows an example of a clamping device 50 in which a pulling device 1 according to FIG. 1 is installed.

The clamping device is configured to be attached to a base unit 80, which is only indicated schematically and in which there is a pushing piston with piston rod 81 for generating a pushing force acting in the pushing direction D. In the present example, the clamping device 50 is designed to clamp a rotationally symmetrical workpiece 70. The workpiece 70 may be, for example, a spur gear. Accordingly, the base unit 80 may be mounted on a workpiece spindle of a machine tool.

The clamping device 50 comprises a base body 51, which in the present example is constructed in two parts. A part of the base body 51 arranged on the left in FIG. 2 forms a clamping device base 52. The clamping device base 52 serves to connect the clamping device to the base unit 80. For this purpose, it has a plane end face with which it rests on a mating surface of the base unit 80. A centering ring 59 extends along the longitudinal axis L into a central recess of the base unit 80. In this way, concentricity and axial runout of the clamping device 50 are ensured. Cylinder screws are used to fix the clamping device 50 to the base unit 80.

The clamping device further comprises a clamping element 53 in the form of a collet. The collet is connected to an actuating rod 56, which is arranged axially displaceably in the base body 51 and extends along the central longitudinal axis L from the clamping element 53 in the pulling direction Z. Anti-rotation screws 57 engage in longitudinal grooves of the actuating rod 56 and thus secure it against rotation. At its free end, the actuating rod 56 has an internal thread, which is screwed onto the external thread of the pull rod 12 of the pulling device 1. This provides an axially fixed connection between the pull rod 12 and the actuating rod 56. The screw connection can be adjusted or released by turning the actuating rod after the anti-rotation screws 57 have been loosened.

To clamp a workpiece 70, it is pushed axially onto the collet until it rests against an abutment ring 55. By pulling on the actuating rod 56, the collet is pulled onto a conical base mandrel 54, which is formed at the end of the base body 51, and thereby expanded. In this manner, a clamping connection is made with the workpiece 70. The clamping connection is released again by an opposite movement of the actuating rod 56.

The pulling device 1 is used to generate the pulling movement of the actuating rod 56. In order to accommodate the pulling device 1, a central bore open to the left, i.e. in the pulling direction, is formed in the base body 51 along the central longitudinal axis L. The bore tapers gradually from left to right. The pulling device 1 is inserted into the bore from the left end. In the area of one of the steps of the bore, the housing of the pulling device 1 rests at the end against an annular wall area of the base body 51 and is thus prevented from being pushed further to the right into the bore.

Distributed around the circumference of the base body, a number of locking screws 60 are screwed into radial holes in the base body. The locking screws project into corresponding blind holes on the outside of the housing of the pulling device and thus fix the pulling device axially and radially in the base body, acting as securing elements for the detachable connection between the base body 51 and the pulling device 1.

The clamping device 50 can now be actuated by generating an axial movement of the piston rod 81 in the pushing direction D. The pulling device 1 converts this movement into a pulling movement of the actuating rod 56 in the pulling direction Z.

The pulling device 1 can be completely removed from the base body 51 as a complete unit. To do this, the anti-rotation screws 57 are first loosened and the actuating rod 56 is unscrewed from the drawbar 12. Now the locking screws 60 are loosened. The pulling device 1 can now be pulled completely out of the bore of the base body 51.

The pulling device 1 thus forms a self-contained, compact unit which, similar to a cartridge, is detachably accommodated in the base body 51 and can be completely removed as a whole from the base body without dismantling the base body 51, in particular without detaching the clamping device base 52 from the rest of the base body 51. As a result, the pulling device 1 can be replaced or serviced very easily. By allowing the spring preload of the return spring 40 to be adjusted by a simple screw movement of the counterpressure element 41, it is easy to adapt the spring preload to different requirements.

### Modifications

The invention is not limited by the foregoing examplary embodiment, and multiple variations are possible without departing from the scope of the invention.

For example, the return spring need not be arranged concentrically around the pull rod, but may also extend offset to it. In this case in particular, there may also be two or more return springs which are arranged, for example, distributed over the circumferential direction parallel to the pull rod. The return spring or return springs need not necessarily be part of the pulling device 1. They may also be arranged at another location in the clamping device.

For example, a return spring may surround the actuating rod 56.

The return spring need not be an elastomer spring. For example, it may also be a compression-acting helical spring or disc spring.

The pulling device does not necessarily have to be arranged centrally axially in the base body of the clamping device. It may also be arranged obliquely or transversely, for example.

The pulling device may also be fixed in the base body in a way other than by radial screws, for example by a locking ring.

The actuating rod 52 may be connected to the pull rod 12 by means other than a threaded connection, such as pinning, clamping, or a bayonet connection.

The clamping device may be designed not only for clamping spur gears, but also for clamping other externally or internally toothed workpieces, workpieces without toothing, tools or other objects. Preferably, the object is at least approximately rotationally symmetrical, and the clamping device is configured to be mounted on a rotationally drivable spindle to cause the object to rotate about its longitudinal axis. If the clamping device is configured for clamping a tool, the tool may in particular be a tool for gear machining, e.g. a grinding tool such as a grinding worm or a profile grinding wheel.

1. A pulling device for generating a pulling movement in a clamping device, comprising:
a pull-acting hydraulic working cylinder having a pull piston displaceable along a longitudinal axis;
a pull rod connected to the pull piston;
a push-acting hydraulic pump cylinder having a pump piston displaceable therein; and
a fluidic connection between the pump cylinder and the working cylinder so that a hydraulic fluid is interchangeable between the pump cylinder and the working cylinder,
wherein a movement of the pump piston in a pushing direction along the longitudinal axis causes the hydraulic fluid to flow from the pump cylinder into the working cylinder and there causes a pulling movement of the pull piston and the pull rod connected thereto in a pulling direction along the longitudinal axis, the pulling direction being opposite to the pushing direction, and
wherein the pump cylinder and the working cylinder are arranged coaxially to each other in a housing of the pulling device.

2. The pulling device according to claim 1, wherein the working cylinder is annular and radially surrounds the pump cylinder.

3. The pulling device according to claim 2,
wherein the housing has a continuous central bore along the longitudinal axis,
wherein the pulling device comprises an insert received in the central bore of the housing,
wherein the pull piston is annular and is displaceably arranged in an annular space between the insert and the housing, the annular space forming the working cylinder,
wherein the pull rod extends outwardly through the central bore of the housing,
wherein the pump piston is displaceably arranged in a central bore of the insert, the central bore forming the pump cylinder, and
wherein the central bore of the insert is fluidically connected to the annular space between the insert and the housing through one or more lateral openings in the insert.

4. The pulling device according to claim 1, further comprising a return spring for returning the pull piston to an initial position, the return spring being a compression spring and being arranged outside the working cylinder, the return spring being axially arranged between a support element, which is arranged fixed relative to the housing, and a counterpressure element, which is connected to the pull rod, in such a way that the pulling movement of the pull rod causes compression of the return spring.

5. The pulling device according to claim 4, wherein the return spring is arranged outside the housing.

6. The pulling device according to claim 4, wherein an axial position of the counterpressure element on the pull rod is adjustable to change a biasing force of the return spring.

7. The pulling device according to claim 6,
wherein the pull rod has an external thread, and
wherein the counterpressure element has an internal thread complementary to the external thread,
so that the axial position of the counterpressure element on the pull rod is adjustable by a screw movement.

8. The pulling device according to claim 4, wherein the return spring is an elastomer spring.

9. The pulling device according to claim 4, wherein the return spring radially surrounds the pull rod.

10. A clamping device, comprising:
a one-piece or multi-piece base body forming a clamping device base for connection to a machine part;
a pull-actuated clamping element for making a clamping connection with an object to be clamped; and
the pulling device according to claim 1,
wherein the pulling device is detachably arranged in the base body, and
wherein the clamping element is detachably connected to the pull rod of the pulling device in such a way that the clamping element is actuable by the pulling movement of the pull rod.

11. The clamping device according to claim 10, wherein the pulling device is received in the base body in such a way that it is completely removable from the base body without dismantling the base body.

12. The clamping device according to claim 11, comprising a securing element which effects a releasable connection between the base body and the pulling device, the pulling device being fixed to the base body in a fixed state of the securing element and being removable from the base body in a released state of the securing element.

13. The clamping device according to claim 11,
wherein the base body has a central axial bore along the longitudinal axis, and
wherein the pulling device is received in the central axial bore of the base body in such a way that it is completely removable from the base body without dismantling the base body.

14. The clamping device according to claim 11, wherein the clamping device comprises a return spring formed separately from the pulling device for returning the pull piston of the pulling device to an initial position.
